(19) United States
(12) Patent Application Publication
(10) Pub. No.: US 2025/0249679 A1
(43) Pub. Date: Aug. 7, 2025

(54) METHOD AND SYSTEM FOR CONTROLLING DROP COLLISIONS IN A DROP ON DEMAND PRINTING APPARATUS

(71) Applicant: Piotr JEUTÉ, Warszawa (PL)

(72) Inventor: Piotr JEUTÉ, Warszawa (PL)

(21) Appl. No.: 19/188,077

(22) Filed: Apr. 24, 2025

Related U.S. Application Data
(63) Continuation of application No. 17/765,337, filed on Mar. 30, 2022, now Pat. No. 12,291,026.

(51) Int. Cl. B41J 2/045

(52) U.S. Cl. CPC B41J 2/04526; B41J 2/04586

(57) ABSTRACT

A method of printing using drop-on-demand collision of multiple liquid drops, the method including: discharging a first liquid drop from a first dispenser and a second liquid drop from a second dispenser so that the first and second liquid drops coalesce in flight and form a combined drop; measuring, via at least one sensor, at least one flight parameter of the combined drop while the combined drop is in flight; comparing the measured flight parameter to a target criterion; and based on the comparison, automatically adjusting at least one discharge parameter for at least one of the first dispenser or the second dispenser before a subsequent discharge, wherein the method is performed in a printing apparatus configured to deposit the combined drop onto a substrate to form part of a printed structure.

### TECHNICAL FIELD

The present invention relates to controlling drop collisions in a drop on demand printing apparatus, wherein at least two drops are discharged to combine in flight. The method is applicable in particular to reactive inkjet printing or 3D printing methods.

### BACKGROUND

Drop on demand is a well known inkjet printing technique, wherein a drop of ink is discharged from a nozzle towards a surface to be printed. The nozzle can be controlled to for example select appropriate discharge time, drop size, drop direction etc.

The drop on demand technique was recently proposed for additive manufacturing applications (also called 3D printing), for example in PCT applications WO2016135294 or WO2016135296, wherein at least two drops are discharged to combine in flight and coalesce into a combined drop.

In order for the drops to combine in flight, the nozzles must be controlled with a high precision. The drop flight parameters may depend on many factors, such as the ambient temperature, humidity, pressure, etc.

There is a need to provide a method that would allow precise control of the drop on demand coalescence process.

### SUMMARY

There is disclosed a method for controlling drop collisions in a drop on demand printing apparatus, comprising discharging a first drop from a first dispenser to move along a first path and discharging a second drop from a second dispenser to move along a second path that crosses with the first path such that the drops are expected to collide and form a combined drop, characterized by: measuring the collision of the drops; examining whether the collision was effected as expected; if the collision was not effected as expected, altering the parameters of dispensing of the drops from the dispensers.

The collision can be measured by capturing an image of the combined drop. The image can be captured by stroboscopic camera.

The collision can be measured by at least one laser and at least one detector configured to determine a change of intensity of light emitted by the lasers as the combined drop alters the path of light between the at least one laser and detector.

Examining whether the collision was effected as expected may include analyzing at least one of: geometrical parameter (X) of collided drops or Weber number.

Examining whether the collision was effected as expected may include analyzing of a path of flight of the combined drop.

The method may comprise altering at least one of: time of discharge of drop, speed of discharge of drop, drop size.

There is also disclosed a system for controlling drop collisions in a drop on demand printing apparatus, comprising a first dispenser for discharging a first drop to move along a first path and a second dispenser for discharging a second drop to move along a second path that crosses with the first path such that the drops are expected to collide and form a combined drop, the system comprising a collision analyzer configured to: measure the collision of the drops using a sensor; examine whether the collision was effected as expected; if the collision was not effected as expected, alter the parameters of dispensing of the drops from the dispensers via dispenser controllers.

In a specific aspect, the invention relates to a method of printing using drop-on-demand collision of multiple liquid drops, the method comprising: discharging a first liquid drop from a first dispenser and a second liquid drop from a second dispenser so that the first and second liquid drops coalesce in flight and form a combined drop; measuring, via at least one sensor, at least one flight parameter of the combined drop while the combined drop is in flight; comparing the measured flight parameter to a target criterion; and based on the comparison, automatically adjusting at least one discharge parameter for at least one of the first dispenser or the second dispenser before a subsequent discharge, wherein the method is performed in a printing apparatus configured to deposit the combined drop onto a substrate to form part of a printed structure.

In another aspect, the invention relates to a method of producing a three-dimensional object by combining drops in flight, the method comprising: providing a drop-on-demand printhead having at least two nozzles each dispensing a respective liquid; selectively discharging a plurality of first drops from a first nozzle and a plurality of second drops from a second nozzle such that at least some of the first and second drops coalesce in flight and form a plurality of combined drops; directing the combined drops onto a build surface to form layers of a three-dimensional object; and during the build process, monitoring a collision outcome of at least one pair of said first and second drops via a measurement system and automatically modifying one or more nozzle control parameters to maintain a desired collision outcome for subsequent drops.

The flight parameter may comprise at least one of: a velocity of the combined drop, a size or volume of the combined drop, a trajectory of the combined drop, or a shape descriptor of the combined drop.

The measurement system may include a camera operated to capture the coalescence in flight under stroboscopic illumination and determine at least one of said flight parameters.

The step of automatically adjusting at least one discharge parameter may comprise changing at least one of: a timing of discharge of one of the drops, a velocity of discharge of one of the drops, a volume of one of the drops, or a pressure condition at a nozzle.

The first liquid may comprise a first polymerizable resin and the second liquid may comprise a second polymerizable resin, and wherein the collision outcome includes onset of a curing reaction in-flight.

The method may further comprise detecting whether any satellite drops are generated as a result of the collision of the first and second liquid drops in flight, and adjusting a discharge parameter to reduce formation of such satellite drops.

The flight parameter that is measured may include an angle of impact between the first and the second liquid drops, and wherein the automatically adjusting step comprises altering a discharge timing to achieve a predetermined collision angle.

The method may further comprise controlling an environmental condition selected from at least one of ambient humidity, ambient temperature, or air pressure in an enclosure surrounding the dispensers, in order to maintain a desired coalescence behavior of the first and second liquid drops.

The step of measuring may comprise capturing images of the collision at two or more distinct positions along a flight path of the first and second liquid drops prior to collision, determining a predicted collision point from said images, and using that information to enhance precision of the subsequent collision.

The method may further comprise providing a third dispenser configured to discharge a third drop that merges with the combined drop to form a multi-component drop before depositing onto the build surface.

The automatically modifying step may include adjusting a ratio of discharge rates between the first nozzle and the second nozzle to achieve a predetermined composition of the combined drop on the build surface.

The step of automatically modifying one or more nozzle control parameters may comprise repositioning or reorienting at least one nozzle relative to the other in order to alter the collision angle and trajectory of the drops before they coalesce.

In another aspect, the invention relates to a drop-on-demand printing system configured to coalesce drops in flight, comprising: at least a first dispenser and a second dispenser, each configured to discharge drops of respective liquids along intersecting paths; a substrate positioned to receive combined drops formed by coalescence of the drops discharged from the first and second dispensers; at least one sensor arranged to observe a flight parameter of at least one combined drop while in flight; and a control unit operatively coupled with the dispensers and the at least one sensor, wherein the control unit is configured to: compare the observed flight parameter to a target criterion; and automatically modify one or more discharge settings of at least one of the first dispenser or the second dispenser if the observed flight parameter deviates from the target criterion, whereby the system operates in a feedback loop to regulate collisions of the drops for printing purposes.

The at least one sensor is selected from the group consisting of: a stroboscopic camera, a high-speed camera, at least one laser and detector configured to detect a change in transmitted or reflected light, or a plurality of optical sensors forming an array for detecting drop trajectories.

The control unit or controller includes a neural network or machine-learning module configured to adapt discharge parameters based on observed collision outcomes over multiple print cycles.

### BRIEF DESCRIPTION OF DRAWINGS

The present invention is shown by means of example embodiments on a drawing, in which:

FIG. 1 shows a system for controlling the coalescence process.

FIGS. 2A-2C show examples of collisions between drops.

FIG. 3 shows calculating geometrical parameter X.

FIG. 4 shows an example schematic arrangement of lasers and detectors.

### DETAILED DESCRIPTION

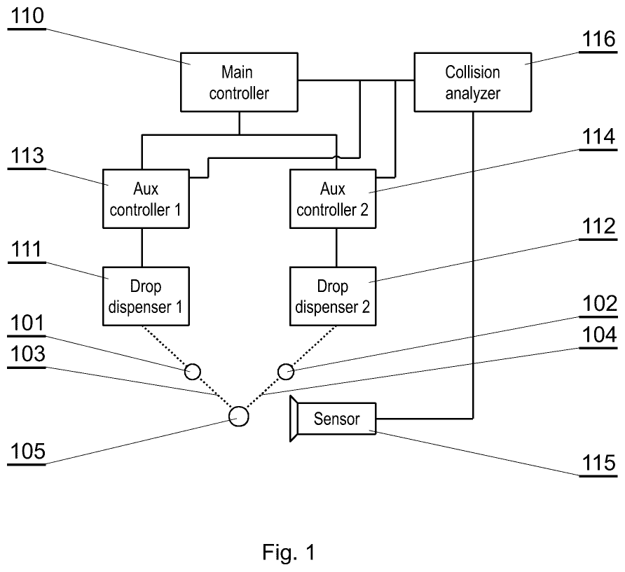

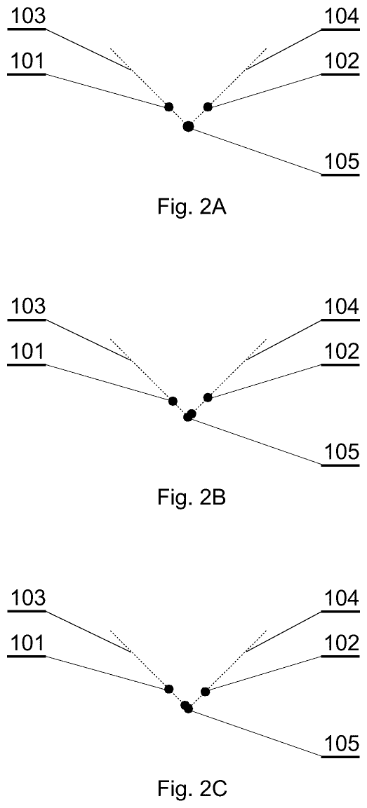

A system for which the method according to the invention is applicable is shown in FIG. 1. The system comprises a main controller 110 that controls two drop dispensers 111, 112. A first primary drop 101 is discharged from the first dispenser 111 and moves along a first path 103 and a second primary drop 102 is discharged from the second dispenser 112 and moves along a second path 104 that crosses with the first path 103. At the crossing point the drops may collide and form a combined drop 105 or be subject to other phenomena, depending on the nature of the liquids from which the drops are formed (for example, the drops may bounce, separate with satellite drops or fragment into smaller drops).

Various factors may affect the paths of flight 103, 104 and properties of drops 101, 102, such that the real path of the drop may deviate from the expected one. For example, ambient environment parameters: humidity, temperature, pressure. Moreover, the actual properties of liquid, e.g. density or viscosity, may deviate from expected properties. Moreover, the drop dispensers may change their operation in course of the printing process, for example if the level of the ink drops due to printing, the hydrostatic pressure at the end of the dispenser changes. Moreover, the drop dispensers 111, 112 may be subject to wear (for example, they may become partially clogged by the liquid material solidifying on the discharge opening) and the parameters of drops may vary as well.

Consequently, the drops may become shifted with respect to each other and not collide centrally as planned or the crossing point of the paths of flight may become shifted. This may result in collisions that do not conclude as planned (for example, a path of the combined drop may shift from the expected path) or the drops may even not collide at all.

A sensor 115, such as a camera, is provided to observe an area in which the collision of the drops is expected to occur. For example, the camera can be a stroboscopic camera or generally a camera having a sufficiently high shutter speed. The sensor 115 measures the trajectories and velocities of the drops and checks if the collision has occurred. For example, it captures an image at the time of collision (or captures a sequence of images and selects the one on which the collision is best visible or calculates whether the collision has occurred from drop parameters measured by previous images). That measurement is sent to a collision analyzer 116 that examines whether the collision was effected as planned and if not, what was the possible cause of deviation from expected collision. If a cause of problem is determined, the analyzer 116 sends a signal to the main controller 110 and/or to auxiliary controllers 113, 114 of the drop dispensers 111, 112 to correct the drop generation parameters such as to improve the collision parameters to bring them closer to expected. Therefore, the system operates in a feedback loop.

For example, the system may be used for controlling a printing head such as described in PCT applications WO2016135294 or WO2016135296.

For example, the first liquid that forms the first primary drop may comprise a first polymer-forming system (preferably, one or more compounds such as a monomer, an oligomer (a resin), a polymer etc., or a mixture thereof) and the second liquid that forms the second primary drop may comprise a second polymer-forming system (preferably, one or more compounds such as a monomer, an oligomer (a resin), a polymer, an initiator of a polymerization reaction, one or more crosslinkers etc., or a mixture thereof). A chemical curing reaction is initiated between the component(s) of the first liquid forming the first primary drop and the component(s) of the second liquid forming the second primary drop when the primary drops coalesce. The chemical curing reaction may be a polyreaction or copolyreaction, which may involve crosslinking, such as polycondensation, polyaddition, radical polymerization, ionic polymerization or coordination polymerization. In addition, the first liquid and the second liquid may comprise other substances such as solvents, dispersants etc.

Alternatively, the liquids may be inks of different colors.

Alternatively, the liquids may be liquids that detonate when in contact with each other.

For all these applications, for precise control of the printing process it is important that the collision is effected as planned: the primary drops shall meet at the specified point at specified time.

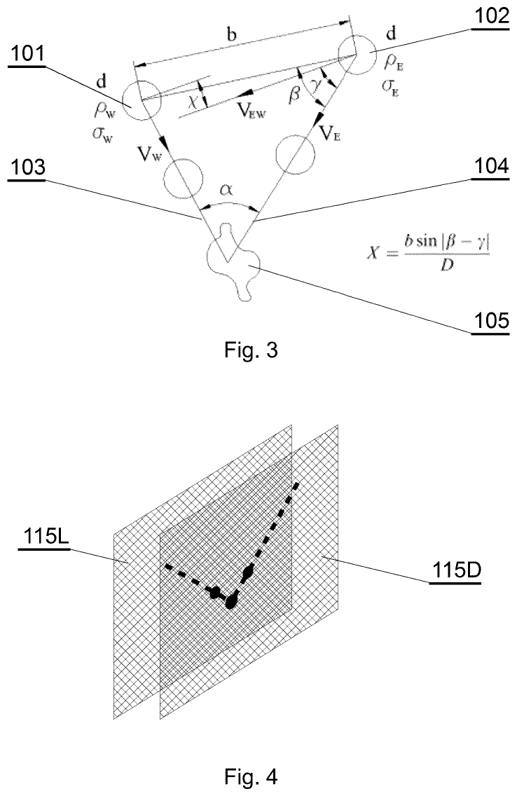

The collision analyzer may operate according to a predefined algorithm that analyzes typical collision errors. These can be detected by measuring collision parameters, such as a geometrical parameter X as described in “Collision between an ethanol drop and a water drop” (by T.-C. Gao et al, Experiments in Fluids, June 2005, Volume 38, Issue 6, pp 731-738) and shown in FIG. 3.

For example, if the image shows that the first drop arrived at the crossing point later than the second drop, the time of discharge of the following first drop may be adapted so as to discharge it earlier than planned. For example, if the image shows that the first drop is smaller than expected, the dispenser of the first drop may be controlled to generate the next first drop that is larger. For example, if the combined drop, after collision, travels along a path that is shifted with respect to the expected path, the speed with which one of the drops is discharged may be changed.

Other sensors 115 can be used as well, for example an array of lasers 115L located at one side of the plane of flight of the drops and an array of detectors 115D located opposite that plane and configured to detect the change of light intensity received from the lasers as the moving drops alter the line of sight between the lasers and detectors and as the combined drop forms. An example schematic arrangement of the lasers and detectors is shown in FIG. 4.

Furthermore, the paths of the moving drops can be analyzed by measuring the time at which the drops have reached certain positions, for example positions at ⅓ and ⅔ of distance between the starting point and the expected collision point, which can be estimated by the array as described before or two arrays (each located at the measurement positions) or by linear laser beams (located at the measurement positions).

Regardless of the type of sensor 115, other measurements of the collision can be performed as well, such as calculating the energetic parameter, Weber number etc. Further, the collision may be analyzed by determining the path of flight of the combined drop-for example by checking whether the combined drop travels along a predetermined path or whether the actual path of the combined drop is deviated from the predetermined path.

Alternatively, the collision analyzer may comprise a neural network that continuously analyzes the measurements by the sensor 115, generates correcting signal and analyzes the following measurements to determine what was the effect of a particular correcting signal. The neural network may be provided in a pre-learned state and next learn further and adapt automatically to the current environment.

Moreover, the analyzer may detect satellite drops, i.e. smaller drops that are generated upon collision e.g. due to collision angle different than planned.

The measurements may be made for each collision (if the analyzer is fast enough) or for selected drops, or periodically, e.g. 1 measurement per second.

The aim of the analyzer is therefore to alter the parameters of dispensing of the drops such that the observed parameter of collided drops is kept within acceptable limits.

By controlling one parameter of dispensing of drops (e.g. a time of dispensing, speed of discharge of drop, drop size), the observed parameter of collided drops can be kept at a stable level even if other parameters of dispense change (e.g. speed of dispense, which may change e.g. due to change in pressure). For example, the parameters of drop dispensing may be altered by controlling the dispensers, such as controlling the discharge force (to control the speed of discharge) or discharge pulse duration (to control the drop size).

Moreover, the present invention allows not only to keep the observed parameter within desired limits, but also to change that limit (e.g. to change a value of parameter X from a positive value to a negative value) in order to for example control the positioning of the combined drop on the printed substrate.

1. A method of printing using drop-on-demand collision of multiple liquid drops, the method comprising:
(a) discharging a first liquid drop from a first dispenser and a second liquid drop from a second dispenser so that the first and second liquid drops coalesce in flight and form a combined drop;
(b) measuring, via at least one sensor, at least one flight parameter of the combined drop while the combined drop is in flight;
(c) comparing the measured flight parameter to a target criterion; and
(d) based on the comparison, automatically adjusting at least one discharge parameter for at least one of the first dispenser or the second dispenser before a subsequent discharge,
wherein the method is performed in a printing apparatus configured to deposit the combined drop onto a substrate to form part of a printed structure.

2. The method of claim 1, wherein the flight parameter comprises at least one of:
a velocity of the combined drop, a size or volume of the combined drop, a trajectory of the combined drop, or a shape descriptor of the combined drop.

3. The method of claim 1, wherein the measurement system includes a camera operated to capture the coalescence in flight under stroboscopic illumination and determine at least one of said flight parameters.

4. The method of claim 1, wherein the step of automatically adjusting at least one discharge parameter comprises changing at least one of:
a timing of discharge of one of the drops,
a velocity of discharge of one of the drops,
a volume of one of the drops, or
a pressure condition at a nozzle.

5. The method of claim 1, wherein the first liquid comprises a first polymerizable resin and the second liquid comprises a second polymerizable resin, and wherein the collision outcome includes onset of a curing reaction in-flight.

6. The method of claim 1, further comprising detecting whether any satellite drops are generated as a result of the collision of the first and second liquid drops in flight, and adjusting a discharge parameter to reduce formation of such satellite drops.

7. The method of claim 1, wherein the flight parameter that is measured includes an angle of impact between the first and the second liquid drops, and wherein the automatically adjusting step comprises altering a discharge timing to achieve a predetermined collision angle.

8. The method of claim 1, further comprising controlling an environmental condition selected from at least one of ambient humidity, ambient temperature, or air pressure in an enclosure surrounding the dispensers, in order to maintain a desired coalescence behavior of the first and second liquid drops.

9. The method of claim 1, wherein the step of measuring comprises capturing images of the collision at two or more distinct positions along a flight path of the first and second liquid drops prior to collision, determining a predicted collision point from said images, and using that information to enhance precision of the subsequent collision.

10. A method of producing a three-dimensional object by combining drops in flight, the method comprising:
(a) providing a drop-on-demand printhead having at least two nozzles each dispensing a respective liquid;
(b) selectively discharging a plurality of first drops from a first nozzle and a plurality of second drops from a second nozzle such that at least some of the first and second drops coalesce in flight and form a plurality of combined drops;
(c) directing the combined drops onto a build surface to form layers of a three-dimensional object; and
(d) during the build process, monitoring a collision outcome of at least one pair of said first and second drops via a measurement system and automatically modifying one or more nozzle control parameters to maintain a desired collision outcome for subsequent drops.

11. The method of claim 10, wherein the flight parameter comprises at least one of: a velocity of the combined drop, a size or volume of the combined drop, a trajectory of the combined drop, or a shape descriptor of the combined drop.

12. The method of claim 10, wherein the measurement system includes a camera operated to capture the coalescence in flight under stroboscopic illumination and determine at least one of said flight parameters.

13. The method of claim 11, wherein the step of automatically adjusting at least one discharge parameter comprises changing at least one of:
a timing of discharge of one of the drops,
a velocity of discharge of one of the drops,
a volume of one of the drops, or
a pressure condition at a nozzle.

14. The method of claim 11, wherein the first liquid comprises a first polymerizable resin and the second liquid comprises a second polymerizable resin, and wherein the collision outcome includes onset of a curing reaction in-flight.

15. The method of claim 11, further comprising providing a third dispenser configured to discharge a third drop that merges with the combined drop to form a multi-component drop before depositing onto the build surface.

16. The method of claim 11, wherein the automatically modifying step includes adjusting a ratio of discharge rates between the first nozzle and the second nozzle to achieve a predetermined composition of the combined drop on the build surface.

17. The method of claim 11, wherein the step of automatically modifying one or more nozzle control parameters comprises repositioning or reorienting at least one nozzle relative to the other in order to alter the collision angle and trajectory of the drops before they coalesce.

18. A drop-on-demand printing system configured to coalesce drops in flight, comprising:
(a) at least a first dispenser and a second dispenser, each configured to discharge drops of respective liquids along intersecting paths;
(b) a substrate positioned to receive combined drops formed by coalescence of the drops discharged from the first and second dispensers;
(c) at least one sensor arranged to observe a flight parameter of at least one combined drop while in flight; and
(d) a control unit operatively coupled with the dispensers and the at least one sensor, wherein the control unit is configured to:
compare the observed flight parameter to a target criterion; and
automatically modify one or more discharge settings of at least one of the first dispenser or the second dispenser if the observed flight parameter deviates from the target criterion,
whereby the system operates in a feedback loop to regulate collisions of the drops for printing purposes.

19. The system of claim 18, wherein the at least one sensor is selected from the group consisting of: a stroboscopic camera, a high-speed camera, at least one laser and detector configured to detect a change in transmitted or reflected light, or a plurality of optical sensors forming an array for detecting drop trajectories.

20. The system of claim 18, wherein the control unit or controller includes a neural network or machine-learning module configured to adapt discharge parameters based on observed collision outcomes over multiple print cycles.
